(19) United States
(12) Patent Application Publication
(10) Pub. No.: US 2015/0042960 A1
(43) Pub. Date: Feb. 12, 2015

(54) OPTICAL FIBER FIXING STRUCTURE AND PROJECTOR

(71) Applicant: Terumasa Kobayashi, Tokyo (JP)

(72) Inventor: Terumasa Kobayashi, Tokyo (JP)

(21) Appl. No.: 14/378,062

(22) PCT Filed: Mar. 16, 2012
(86) PCT No.: PCT/JP2012/056901

§ 371 Date: Aug. 11, 2014

(51) Int. Cl. G02B 6/36; H04N 9/31

(52) U.S. Cl. CPC G02B 6/3624; H04N 9/3161
USPC 353/31; 385/137

(57) ABSTRACT

An optical fiber fixing structure for fixing a fiber bundle that covers a plurality of bundled optical fibers with a coating and the plurality of optical fibers that are exposed from an end of the coating of the fiber bundle at a predetermined position comprises a first holding section that holds the coating of the fiber bundle, and a second holding section that holds distal end portions of the plurality of optical fibers exposed from the end of the coating of the fiber bundle respectively. The first holding section and the second holding section are integrally formed.

### TECHNICAL FIELD

The present invention relates to an optical fiber fixing structure for fixing an optical fiber at a predetermined position and a projector using the same.

### BACKGROUND ART

A projector using red, green, blue laser beams for light sources may use a plurality of laser light sources for each color to secure brightness of the projected video. Optical fibers are generally used to transmit a laser beam having relatively large output from each laser light source to an optical component of an illumination optical system provided for the projector.

To control color irregularity in the projected video of a projector using laser beams for its light sources, it is necessary to align optical axes of a plurality of optical fibers for transmitting laser beams with the optical axis of the above-described optical component so that the illumination optical system operates as designed. For this reason, high accuracy is required for mounting positions of the respective optical fibers with respect to the optical component. In addition, since the output of each laser beam emitted from a distal end of the optical fiber is large, a structure needs to be adopted in which no laser beam leaks outside the optical component in a connection region between the optical component and the optical fiber. The optical fiber here refers to an uncoated optical fiber core made of an optical fiber elemental wire of quartz glass or the like covered with resin or the like.

When a plurality of optical fibers are bundled as a cable and drawn out of an apparatus provided with a plurality of laser light sources, since a large limitation is imposed on the angle of bending of the optical fiber, a large load will be applied to the fixing region of the cable. On the other hand, since the mechanical strength of the optical fiber is weak, care is required so that the above-described load of the cable will not be applied to the connection region between the optical component and the optical fiber.

For a projector using laser beams for its light sources, it may be preferable to add additional laser light sources for each color to acquire a brighter projected video. Therefore, even when additional laser light sources are introduced and the number of optical fiber cables increases, it is preferable that the projector be easily adaptable to such a change.

Therefore, an apparatus such as a projector using laser beams for its light sources preferably has a fixing structure for optical fibers corresponding to the above-described optical component that can solve these problems.

When optical fibers or optical fiber cables are fixed to an optical device or the like, a cable ground as described, for example, in Patent Literature 1 (Japanese Patent Laid-Open No. 06-214119) is used. Patent Literature 1 describes a configuration in which an optical fiber cable is fixed to an optical cable connection box for internally connecting the optical fibers using the cable ground.

However, the cable ground is intended to be provided at the cable outlet of various apparatuses to hold the cable, and is not intended to guide laser beams emitted from distal ends of the optical fibers to the optical component as described above. Even when the optical fiber cable is fixed to a case or the like using the cable ground, if each optical fiber is exposed from the optical fiber cable so as to accurately mount each optical fiber in the above-described optical component, the load of the optical fiber cable may be applied to the connection region between the optical component and the optical fiber, causing the optical fiber to be damaged.

### RELATED ART LITERATURES

### Patent Literature

Patent Literature 1: Japanese Patent Laid-Open No. 06-214119

### SUMMARY

It is an object of the present invention to provide an optical fiber fixing structure suitable for optical fibers for transmitting laser beams to be used for light sources of an apparatus such as a projector.

An exemplary aspect of the optical fiber fixing structure of the present invention to attain the above-described object is an optical fiber fixing structure for fixing a fiber bundle that covers a plurality of bundled optical fibers with a coating and the plurality of optical fibers that are exposed from an end of the coating of the fiber bundle at a predetermined position, the optical fiber fixing structure including a first holding section that holds the coating of the fiber bundle, and a second holding section that holds distal end portions of the plurality of optical fibers exposed from the end of the coating of the fiber bundle respectively, in which the first holding section and the second holding section are integrally formed.

On the other hand, an exemplary aspect of the projector of the present invention is a projector that projects an image onto a projection plane in accordance with an image signal supplied from outside, the projector including the above-described optical fiber fixing structure and an apparatus body including an optical component to which a plurality of optical fibers are fixed through the optical fiber fixing structure.

### BRIEF DESCRIPTION OF THE DRAWINGS

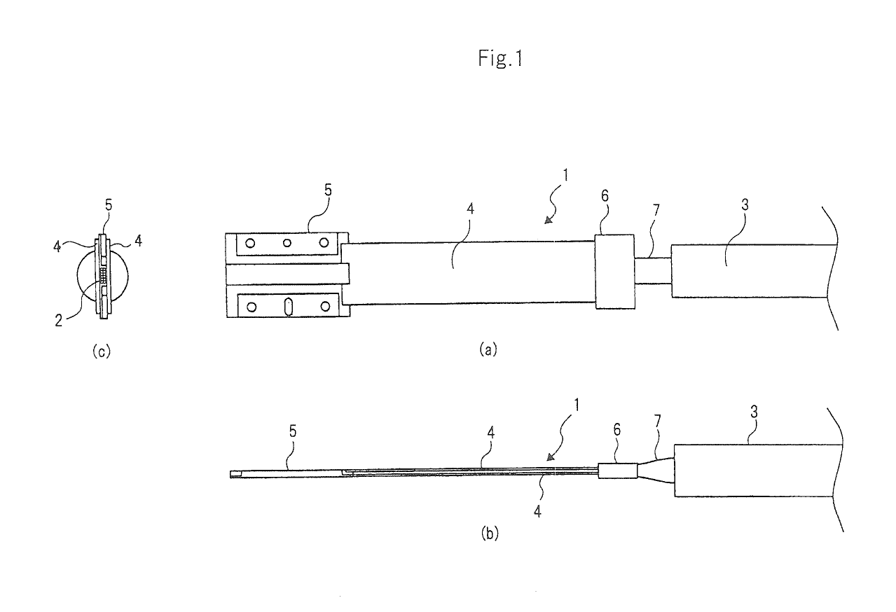

### [FIG. 1]

FIG. 1 is a diagram showing an example of an optical fiber cable according to a first exemplary embodiment; FIG. 1(a) shows a plan view, FIG. 1(b) shows a side view and FIG. 1(c) shows a front view.

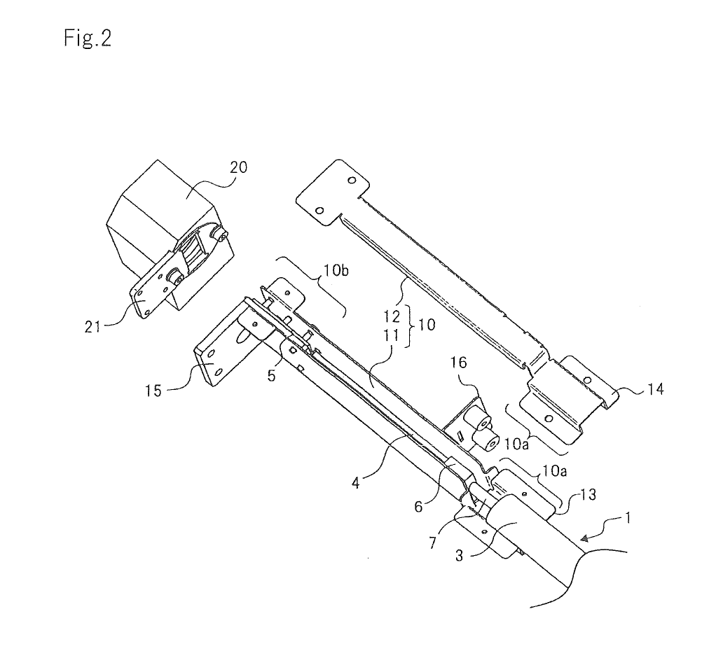

### [FIG. 2]

FIG. 2 is a perspective view showing an example of an optical fiber fixing structure of the first exemplary embodiment.

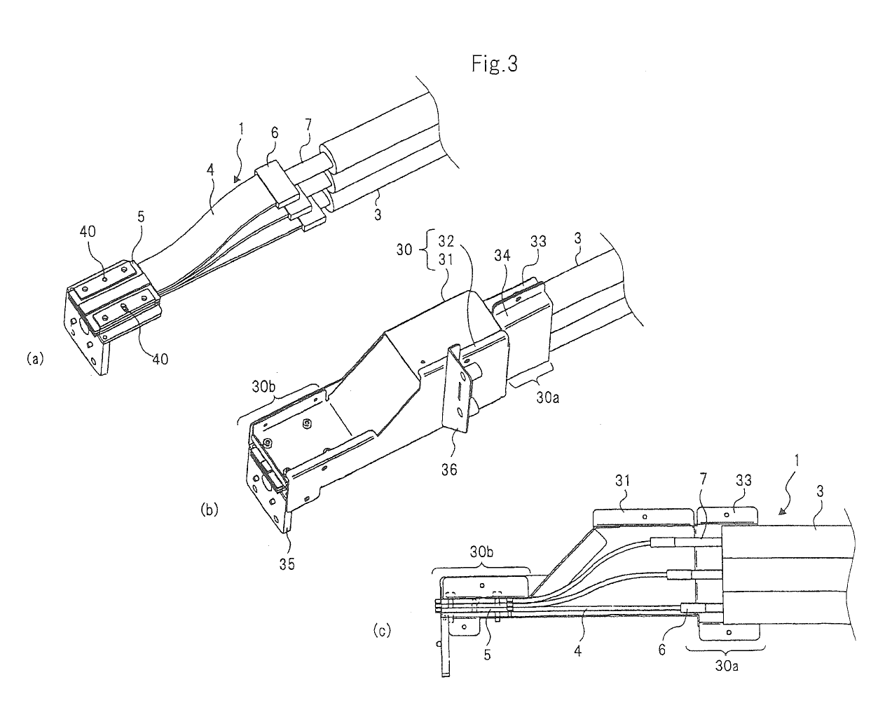

### [FIG. 3]

FIG. 3 is a diagram showing an example of an optical fiber fixing structure according to a second exemplary embodiment; FIG. 3(a) shows a perspective view illustrating a processing example of a distal end portion of an optical fiber cable, FIG. 3(b) shows a perspective view illustrating a situation after a holding metal fitting is attached and FIG. 3(c) shows a cross-sectional view illustrating a situation after the holding metal fitting is attached.

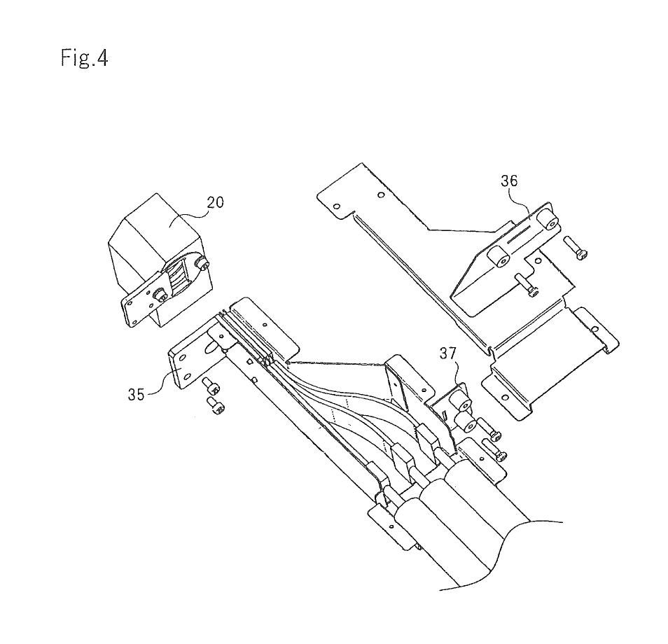

### [FIG. 4]

FIG. 4 is a perspective view showing an example of an optical fiber fixing structure according to a third exemplary embodiment.

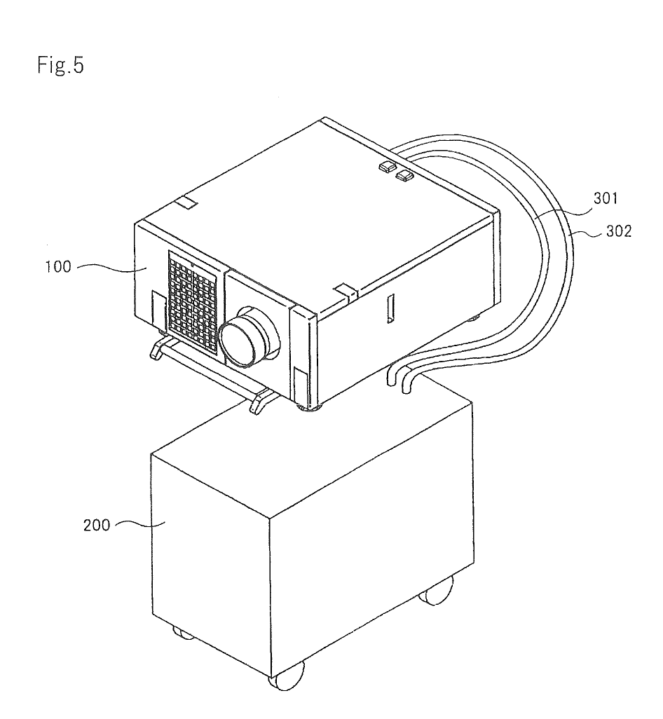

### [FIG. 5]

FIG. 5 is a perspective view showing an example of a projector system of the present invention.

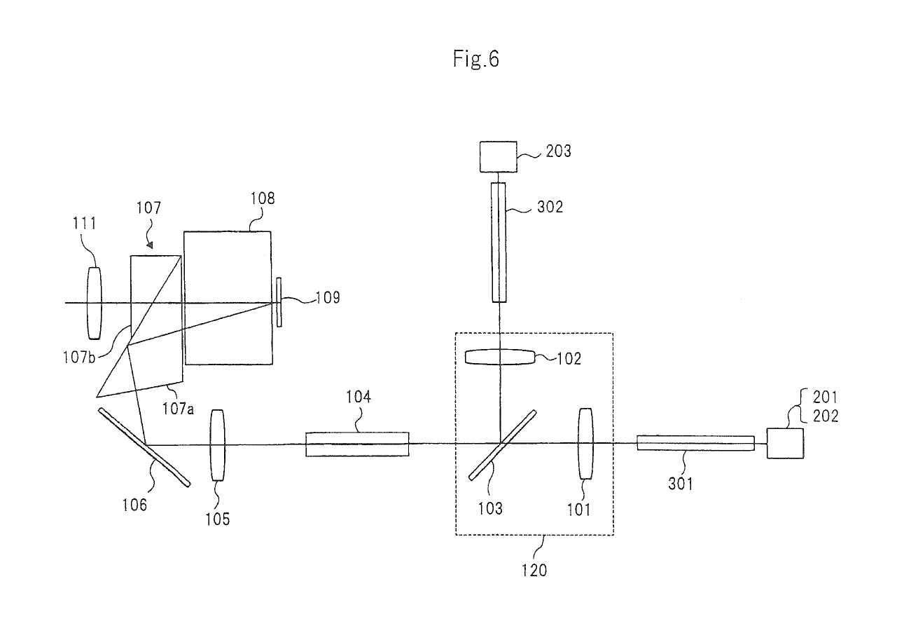

### [FIG. 6]

FIG. 6 is a schematic view showing an example of the structure of the projector system shown in FIG. 5.

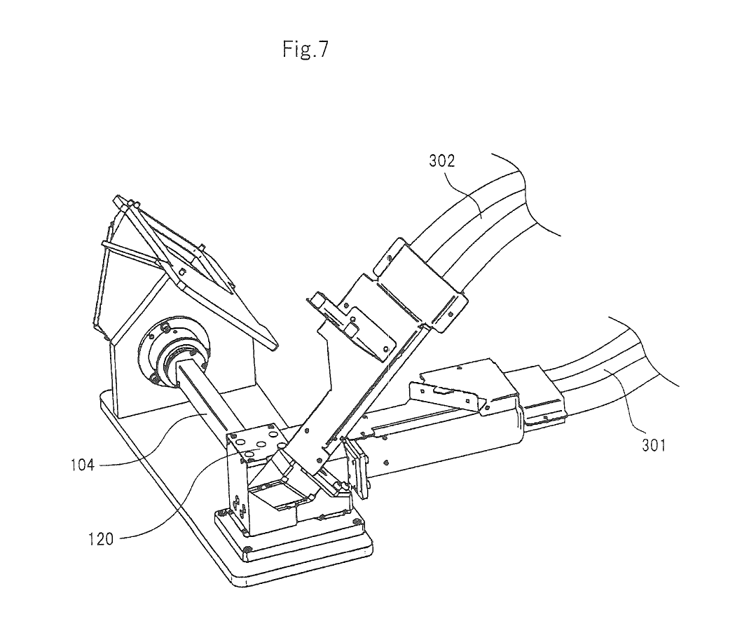

### [FIG. 7]

FIG. 7 is a perspective view showing an example of fixing of the optical fiber cable to the projector body shown in FIG. 5.

### EXEMPLARY EMBODIMENT

Next, the present invention will be described using the accompanying drawings.

### First Exemplary Embodiment

FIG. 1 is a diagram showing an example of an optical fiber cable according to a first exemplary embodiment; FIG. 1(a) shows a plan view, FIG. 1(b) shows a side view and FIG. 1(c) shows a front view.

As shown in FIGS. 1(a) to 1(c), an optical fiber cable 1 of the present exemplary embodiment is provided with fiber bundle 7 which is a plurality of optical fibers 2 drawn from an apparatus provided with a plurality of laser light sources, bundled together and covered with a coating. Fiber bundle 7 may be further covered with protective tube 3 for reducing the bending angle of optical fiber 2. A metal tube made of, for example, bellows-shaped stainless steel is used for protective tube 3. The optical fiber cable 1 shown in FIGS. 1(a) to 1(c) is a configuration example with the coating of fiber bundle 7 covered with protective tube 3.

Optical fiber cable 1 shown in FIGS. 1(a) to 1(c) is provided for each color of, for example, red, green and blue laser beams. Optical fiber cable 1 may also be provided in units of two or three colors.

As shown in FIGS. 1(a) and 1(b), each optical fiber 2 exposed from an end of the coating of fiber bundle 7 is sandwiched between two presser plates 4 and planar fixing metal fitting 5 is fixed on the distal end side of presser plates 4.

A relatively thin aluminum or iron metal plate is used for presser plate 4 so as to bend in a thickness direction. Fixing metal fitting 5 is provided with a planar first fixing section provided with fixing and positioning holes along, for example, both ends and a second fixing section disposed on the first fixing section and having a hat-shaped cross section provided with a notch to avoid the above-described holes in a flange section, having a configuration in which each optical fiber 2 is sealed/fixed using resin or the like inside the hat-shaped section (see FIG. 1(c)). Fixing metal fitting 5 is also used by cutting an end of each optical fiber 2 along an end side thereof to align the end faces with each other.

Presser plates 4 and fixing metal fitting 5 are fixed by, for example, bonding. Presser plates 4 and the end of the coating of fiber bundle 7 are bonded/fixed via relay metal fitting 6 having an oval cross section.

FIG. 2 is a perspective view showing an example of an optical fiber fixing structure according to the first exemplary embodiment.

As shown in FIG. 2, the optical fiber fixing structure of the first exemplary embodiment includes first holding section 10a that holds the coating of fiber bundle 7 shown in FIG. 1 and second holding section 10b that holds distal end portions of a plurality of optical fibers exposed from the end of the coating of fiber bundle 7 respectively, and has a configuration in which first holding section 10a and second holding section 10b are integrally formed. First holding section 10a and second holding section 10b are realized, for example, by holding metal fitting 10 shown in FIG. 2.

Holding metal fitting 10 has a shape covering whole optical fiber 2 exposed from the end of the coating of fiber bundle 7 including the coating of fiber bundle 7, relay metal fitting 6, presser plates 4 and fixing metal fitting 5 shown in FIG. 1.

Holding metal fitting 10 is provided with, for example, first metal fitting 11 having a U-shaped cross section and second metal fitting 12 that serves as a lid of first metal fitting 11, and houses relay metal fitting 6, presser plates 4 and fixing metal fitting 5 shown in FIG. 1 in first metal fitting 11. Fixing sections 13 and 14 that are manufactured so as to have hat-shaped cross sections which serve as above-described first holding section 10a are provided at one end of first metal fitting 11 and second metal fitting 12. Fixing sections 13 and 14 sandwich the end of the coating of fiber bundle 7 or the end of the protective tube 3 shown, for example, in FIG. 1 to hold the coating of fiber bundle 7. Means for fixing fixing metal fitting 5 shown, for example, in FIG. 1 is provided at the other end of first metal fitting 11, which becomes above-described second holding section 10b. Such means can be realized by a plurality of screws and a plurality of screw holes corresponding to the screws for fixing fixing metal fitting 5. Fixing metal fitting 5 may be directly fixed to holding metal fitting 10 or may be fixed to holding metal fitting 10 via a metal plate or the like. First metal fitting 11 and second metal fitting 12 are fixed by screws or the like. A heat-resistant metal material is used for holding metal fitting 10. Use of aluminum, iron or the like in particular facilitates manufacturing and can secure sufficient strength. For example, black color painting may be preferably applied to the interior of holding metal fitting 10 to prevent reflection of laser beams emitted from optical fiber 2.

First protrusion 15 to be fixed to optical component 20 is provided at an end of the surface of holding metal fitting 10 which becomes an end face side of optical fiber 2 and second protrusion 16 to be fixed to an apparatus body (not shown) including optical component 20 is provided at a position away from optical component 20 of the surface of holding metal fitting 10. That is, second holding section 10b is fixed to optical component 20 in the vicinity thereof and first holding section 10a is fixed to the apparatus body including optical component 20 in the vicinity thereof. First protrusion 15 and second protrusion 16 are provided with screw holes, first protrusion 15 is fixed to optical component 20 using screws and second protrusion 16 is fixed to the apparatus body using screws.

Optical component 20 is a target to which holding metal fitting 10 shown in FIG. 2 is attached and is configured to internally hold a lens, mirror or the like of an illumination optical system of, for example, a projector that receives laser beams emitted from the distal end of each optical fiber 2. Optical component 20 is fixed to, for example, the apparatus body.

Optical component 20 is provided with protrusion 21 for attaching holding metal fitting 10 and protrusion 21 is provided with a screw hole and a positioning hole to fix holding metal fitting 10. First protrusion 15 of holding metal fitting 10 is provided with a positioning pin corresponding to the positioning hole and holding metal fitting 10 is guided by the positioning pin to an exact position with respect to optical component 20 and fixed with a screw. Here, the direction in which first protrusion 15 is attached by a screw is preferably parallel to the optical axis of optical component 20. If the direction in which first protrusion 15 is attached is parallel to the optical axis of optical component 20, it is possible to fix each optical fiber 2 at an exact position with respect to optical component 20 irrespective of the strength of attaching of first protrusion 15 to optical component 20.

Directly attaching the end of holding metal fitting 10 which becomes the end face side of the optical fiber to optical component 20 using the positioning pin of first protrusion 15 allows each optical fiber 2 to be fixed accurately so that the optical axes of optical component 20 and each optical fiber 2 are aligned with each other.

According to the present exemplary embodiment, first holding section 10a holds the end of the coating of fiber bundle 7 and second holding section 10b which is integrally formed with first holding section 10a holds the distal end portions of the plurality of optical fibers exposed from the end of the coating of fiber bundle 7 respectively, and it is thereby possible to fix optical fiber 2 at a predetermined position while preventing damage to each optical fiber 2 exposed from the end of the coating of fiber bundle 7.

Furthermore, by fixing first holding section 10a to the apparatus body in the vicinity thereof and fixing second holding section 10b to optical component 20 in the vicinity thereof, it is possible to fix, to the apparatus body with a strong force, holding metal fitting 10 which realizes first holding section 10a and second holding section 10b to which the load of optical fiber cable 1 is applied. Therefore, it is possible to continuously hold each optical fiber 2 at the required fixing position.

Furthermore, as shown in FIG. 2, by covering each optical fiber 2 exposed from the end of the coating of fiber bundle 7 with presser plates 4 and planar fixing metal fitting 5, it is possible to attach holding metal fitting 10 to optical fiber cable 1 and there is no need to be concerned about each exposed optical fiber.

Since entire optical fiber 2 that is exposed from the end of the coating of fiber bundle 7 including presser plates 4, planar fixing metal fitting 5 and relay metal fitting 6 is covered with holding metal fitting 10 that realizes first holding section 10a and second holding section 10b, a laser beam emitted from optical fiber 2 never leaks to the outside. Therefore, it is possible to protect a user of the apparatus from exposure to the laser beam without need to take any special measure.

Furthermore, since holding metal fitting 10 is attached to optical component 20 using a positioning pin, it is possible to fix each optical fiber 2 covered with holding metal fitting 10 to optical component 20 accurately so that the optical axes of optical component 20 and each optical fiber 2 are aligned with each other.

Therefore, it is possible to obtain an optical fiber fixing structure suitable for optical fibers for transmitting the laser beam used for light sources of an apparatus such as a projector.

### Second Exemplary Embodiment

FIG. 3 is a diagram showing an example of an optical fiber fixing structure of a second exemplary embodiment, FIG. 3(a) shows a perspective view illustrating a processing example of the distal end portion of an optical fiber cable, FIG. 3(b) shows a perspective view illustrating a situation after a holding metal fitting is attached and FIG. 3(c) shows a cross-sectional view illustrating a situation after a holding metal fitting is attached.

The second exemplary embodiment illustrates an example of a holding metal fitting when the number of optical fiber cables 1 connected to the apparatus body increases by adding additional laser light sources. More specifically, the second exemplary embodiment shows an optical fiber fixing structure for fixing three optical fiber cables 1 to optical component 20 and the apparatus body including optical component 20.

Our assumption is that each optical fiber cable 1 is provided with fiber bundle 7, relay metal fitting 6, presser plates 4 and fixing metal fitting 5 shown in FIG. 1, and that each optical fiber 2 exposed from the end of the coating of fiber bundle 7 is protected using relay metal fitting 6, presser plates 4 and fixing metal fitting 5 as in the case of the first exemplary embodiment.

As shown in FIG. 3(a), fixing metal fittings 5 for respective optical fiber cables 1 are stacked on one another and fixed to, for example, a metal plate or the like. Each fixing metal fitting 5 may also be directly fixed to a holding metal fitting 30 of the present exemplary embodiment which will be described later. As described above, each optical fiber 2 exposed from fiber bundle 7 is configured to be sandwiched between presser plates 4 made of a relatively thin metal plate which bends in the thickness direction, the distal end region of which is protected by planar fixing metal fitting 5. Thus, as shown in FIG. 3(a), even when presser plates 4 are made to bend, each fixing metal fitting 5 can be stacked without causing any great force to be applied to each optical fiber 2. Each fixing metal fitting 5 is positioned using, for example, two positioning pins 40 so that end faces of respective optical fibers 2 align with each other for each optical fiber cable 1.

As in the case of the first exemplary embodiment, the optical fiber fixing structure of the second exemplary embodiment includes first holding section 30a that holds the coating of each fiber bundle 7 and second holding section 30b that holds the distal end portions of a plurality of optical fibers exposed from the end of the coating of each fiber bundle 7, and this optical fiber fixing structure has a configuration in which first holding section 30a and second holding section 30b are integrally formed. First holding section 30a and second holding section 30b are realized, for example, by holding metal fitting 30 shown in FIGS. 3(b) and 3(c).

Holding metal fitting 30 has a shape covering entire optical fiber 2 exposed from the end of the coating of each fiber bundle 7 including the coating of each fiber bundle 7, relay metal fitting 6, presser plates 4 and fixing metal fitting 5. That is, the present invention changes the shape of the holding metal fitting according to the number of optical fiber cables 1 to be attached to optical component 20.

Holding metal fitting 30 of the present exemplary embodiment is provided with first metal fitting 31 that accommodates relay metal fitting 6, presser plates 4 and fixing metal fitting 5 for each optical fiber cable 1, and second metal fitting 32 that serves as a lid of first metal fitting 31. Fixing sections 33 and 34 that are manufactured so as to have hat-shaped cross sections which serve as first holding section 30a are provided at one end of first metal fitting 31 and second metal fitting 32. Fixing sections 33 and 34 sandwich the end of, for example, protective tube 3 to thereby hold the coating of fiber bundle 7. Means for fixing the plurality of stacked fixing metal fittings 5 shown, for example, in FIG. 3(a) which becomes above-described second holding section 30b is provided at the other end in first metal fitting 31. Such means can be realized by a plurality of screws and a plurality of screw holes corresponding to the screws for fixing fixing metal fitting 5 or the like. Fixing metal fitting 5 may be directly fixed to holding metal fitting 30 or may be fixed to holding metal fitting 30 via a metal plate or the like. First metal fitting 31 and second metal fitting 32 are fixed using screws or the like. For example, a heat-resistant metal material is used for holding metal fitting 30 as in the case of the first exemplary embodiment. For example, black color painting is applied to the interior of holding metal fitting 30 to prevent reflection of the laser beam from being emitted from optical fiber 2.

First protrusion 35 to be fixed to optical component 20 (see FIG. 2) is provided at an end of the surface of holding metal fitting 30 which becomes the end face side of optical fiber 2 as in the case of the first exemplary embodiment and a second protrusion 36 to be fixed to the apparatus body (not shown) including optical component 20 is provided at a position away from optical component 20 of the surface of holding metal fitting 30. That is, second holding section 30b is fixed to optical component 20 in the vicinity thereof and first holding section 30a is fixed to the apparatus body including optical component 20 in the vicinity thereof. First protrusion 35 and second protrusion 36 are provided with screw holes, first protrusion 35 is fixed to optical component 20 using screws and second protrusion 36 is fixed to the apparatus body using screws.

FIGS. 3(a) to 3(c) show an example of the shape of holding metal fitting 30 corresponding to a configuration in which fixing metal fittings 5 of other optical fiber cables 1 are stacked on fixing metal fitting 5 of outside optical fiber cable 1 selected from among three parallel optical fiber cables 1. Holding metal fitting 30 may also have a shape corresponding to a configuration in which fixing metal fittings 5 selected from two outside optical fiber cables 1 are stacked, for example, on fixing metal fitting 5 of center optical fiber cable 1.

As shown in the present exemplary embodiment, even when the number of optical fiber cables 1 increases, fixing metal fittings 5 for respective optical fiber cables 1 may be stacked on one another and the optical fiber fixing structure of the present invention may be changed to holding metal fitting 30 having a shape corresponding to the number of optical fiber cables 1. Thus, in addition to the effect shown in the first exemplary embodiment, even when additional laser light sources are added and the number of optical fiber cables 1 thereby increases, the structure is easily adaptable to such a change.

### Third Exemplary Embodiment

FIG. 4 is a perspective view showing an example of an optical fiber fixing structure according to a third exemplary embodiment.

The optical fiber fixing structure of the third exemplary embodiment is an example where the number of fixing locations of holding metal fitting 30 is different from that of the second exemplary embodiment.

In the third exemplary embodiment as shown in FIG. 4, first protrusion 35 to be fixed to optical component 20 is provided at an end of the surface of holding metal fitting 30 which becomes the end face side of optical fiber 2 and second protrusion 36 and third protrusion 37 to be fixed to the apparatus body (not shown) including optical component 20 are provided at positions away from optical component 20 of the surface of holding metal fitting 30. The number of protrusions for fixing holding metal fitting 30 to the apparatus body is not limited to 2, but may be more than 2. The rest of the configuration is similar to the configuration shown in the second exemplary embodiment, and therefore description thereof will be omitted.

Suppose optical fiber 2 exposed from the end of the coating of fiber bundle 7 of each optical fiber cable 1 is protected using relay metal fitting 6, presser plates 4 and fixing metal fitting 5 shown in FIG. 1 as in the case of the first exemplary embodiment.

As described above, since optical fiber cable 1 has a configuration provided with protective tube 3 that covers fiber bundle 7 or the coating thereof, when the number of optical fiber cables 1 to be fixed to optical component 20 increases, a large load is applied to the connection region thereof.

As shown in the present exemplary embodiment, if the number of fixing locations of holding metal fitting 30 is increased, holding metal fitting 30 to which a plurality of optical fiber cables 1 are attached can be fixed to the apparatus body with a stronger force than that of the second exemplary embodiment. Therefore, each optical fiber 2 can be continuously held at a required fixed position with a stronger force.

### Fourth Exemplary Embodiment

A fourth exemplary embodiment will describe a projector system adopting the optical fiber fixing structure shown in the first exemplary embodiment to the third exemplary embodiment.

FIG. 5 is a perspective view showing an example of a projector system of the present invention and FIG. 6 is a schematic view showing an example of the structure of the projector system shown in FIG. 5. FIG. 7 is a perspective view showing an example of fixing of the optical fiber cable to the projector body shown in FIG. 5.

As shown in FIG. 5, the projector system of the present exemplary embodiment includes projector body 100, laser light source apparatus 200, and optical fiber cables 301 and 302 including a plurality of optical fibers for supplying a laser beam generated in laser light source apparatus 200 to projector body 100.

Laser light source apparatus 200 is provided with a plurality of laser light sources for generating, for example, red, green and blue laser beams. A well-known semiconductor laser, solid laser, gas laser or the like is used for the laser light sources.

Projector body 100 projects images onto a projection plane (screen or the like) using the red, green and blue laser beams generated in laser light source apparatus 200 for the light sources according to image signals supplied from the outside, for example.

Optical fiber cable 301 is configured of a plurality of optical fibers for supplying, for example, the green and blue laser beams generated in laser light source apparatus 200 to projector body 100. Optical fiber cable 302 is configured of a plurality of optical fibers for supplying, for example, the red laser beam generated in laser light source apparatus 200 to projector body 100.

As shown in FIG. 6, projector body 100 is provided with lenses 101 and 102, dichroic mirror 103, rod integrator 104, lens group 105, mirror 106, TIR prism 107, Philips prism 108, DMD (Digital Mirror Device) 109, and projection lens 111.

Laser light source apparatus 200 is provided with first laser light source 201 that generates a green laser beam, a second laser light source 202 that generates a blue laser beam and third laser light source 203 that generates a red laser beam. The green and blue laser beams generated in first laser light source 201 and second laser light source 202 are transmitted to projector body 100 via an optical fiber provided in optical fiber cable 301 and the red laser beam generated in third laser light source 203 is transmitted to projector body 100 via an optical fiber provided in optical fiber cable 302. Although FIG. 6 describes first laser light source 201 and second laser light source 202 that are together, but laser light source apparatus 200 is provided with first laser light source 201 and second laser light source 202. Furthermore, FIG. 6 describes a configuration example in which laser light source apparatus 200 is provided with first laser light source 201 to third laser light source 203, one each, but laser light source apparatus 200 may also be provided with first laser light source 201 to third laser light source 203, each being composed of a plurality of laser light sources. In such a case, pluralities of first laser light sources 201, second laser light sources 202 and third laser light sources 203 are provided with respective optical fibers for transmitting respective laser beams.

The green and blue laser beams emitted from the distal end of each optical fiber of optical fiber cable 301 are inputted to rod integrator 104 via lens 101 and dichroic mirror 103 provided in projector body 100. The red laser beam emitted from a distal end of each optical fiber provided in optical fiber cable 302 is inputted to rod integrator 104 via lens 102 and dichroic mirror 103 provided in projector body 100. Dichroic mirror 103 color-synthesizes the inputted red, green and blue laser beams and emits the color-synthesized laser beam. Lenses 101 and 102, and dichroic mirror 103 constitute laser light synthesizing section 120 for color-synthesizing the red, green and blue laser beams. In the projector system of the present exemplary embodiment, this laser light synthesizing section 120 becomes optical component 20 to which holding metal fitting 10 (or 30) shown in the first to third exemplary embodiments is attached.

Rod integrator 104 repeatedly totally reflects the laser beams inputted from dichroic mirror 103 in such a way that the illuminance distribution becomes uniform and emits uniform laser beams. The laser beams emitted from rod integrator 104 are radiated onto DMD 109 via lens group 105, mirror 106, TIR prism 107 and Philips prism 108.

Lens group 105 is disposed at a position facing the light emission surface of rod integrator 104. The optical axis of lens 101, the optical axis of lens group 105 and the central axis of rod integrator 104 are aligned with each other. Lens group 105 includes a relay optical system. Mirror 106 reflects the laser beam emitted from lens group 105 toward TIR prism 107. TIR prism 107 is composed of, for example, two triangle prisms 107a and 107b, and has a configuration in which part of the slope of triangle prism 107a is pasted to the slope of triangle prism 107b. The laser beam after the color synthesis reflected by mirror 106 is totally reflected on the slope of triangle prism 107a and emitted from the other surface. The red, green and blue laser beams emitted from TIR prism 107 are inputted to Philips prism 108. Philips prism 108 separates the laser beams emitted from TIR prism 107 into red, green and blue luminous fluxes and emits the luminous fluxes from different surfaces.

Three DMDs 109 which are provided in correspondence with the red, green and blue luminous fluxes, are display elements that spatially modulate the red, green and blue luminous fluxes separated in Philips prism 108 to form an image beam for each color. FIG. 6 shows only one DMD 109.

The red, green and blue image beams are color-synthesized in Philips prism 108 and are then emitted to projection lens 111 via TIR prism 107 and projected by projection lens 111 onto a projection plane (screen or the like) (not shown).

In the projector system shown in FIG. 6, lenses 101 and 102, dichroic mirror 103, rod integrator 104, and lens group 105 constitute an illumination optical system.

Although FIG. 6 illustrates a configuration example in which a DMD is used as the display element, other well-known display elements such as a reflection type liquid crystal panel and transmission type liquid crystal panel may also be used for the display element. When the display element is a transmission type liquid crystal panel, a configuration may be adopted in which a laser beam emitted from lens group 105 is radiated onto the liquid crystal panel provided with a spectral filter or the like.

As shown in FIG. 7, the present exemplary embodiment attaches holding metal fitting 10 (or 30) shown in the first to third exemplary embodiments at ends of optical fiber cables 301 and 302 respectively on the projector body 100 side shown, for example, in FIG. 5 and fixes holding metal fitting 10 (or 30) to laser light synthesizing section 120 including lenses 101 and 102, and dichroic mirror 103 shown in FIG. 6. FIG. 7 illustrates an example using holding metal fitting 30 for holding the three optical fiber cables shown in FIGS. 3(a) to 3(c). That is, FIG. 7 illustrates an example in which three laser light source apparatuses 200 shown in FIG. 5 are provided and three optical fiber cables 301, and three optical fiber cables 302 are fixed to projector body 100 respectively.

As shown in the present exemplary embodiment, the present invention can obtain an optical fiber fixing structure suitable for a projector system using laser beams for its light sources.

The present invention has been described with reference to the exemplary embodiments, but the present invention is not limited to the above-described exemplary embodiments. Various modifications understandable to those skilled in the art within the scope of the present invention may be made with respect to the configuration or the details of the present invention.

1. An optical fiber fixing structure for fixing a fiber bundle that covers a plurality of bundled optical fibers with a coating and said plurality of optical fibers that are exposed from an end of the coating of said fiber bundle at a predetermined position, the optical fiber fixing structure comprising:
a first holding section that holds the coating of said fiber bundle; and
a second holding section that holds distal end portions of said plurality of optical fibers exposed from the end of the coating of said fiber bundle respectively,
wherein said first holding section and said second holding section are integrally formed.

2. The optical fiber fixing structure according to claim 1, wherein said first holding section and said second holding section are fixed to an apparatus body comprising an optical component in respective vicinities thereof.

3. The optical fiber fixing structure according to claim 1, further comprising:
a presser plate that bends in a thickness direction provided so as to sandwich said plurality of optical fibers exposed from the end of the coating of said fiber bundle;
a fixing metal fitting fixed to the end face side of said optical fiber of said presser plate to hold said plurality of optical fibers while causing end faces of said plurality of optical fibers to align with each other; and
a relay metal fitting that fixes the end of the coating of said fiber bundle and said presser plate.

4. The optical fiber fixing structure according to claim 3, wherein said first holding section and said second holding section have shapes covering the end of the coating of said fiber bundle, said relay metal fitting, said presser plate and said fixing metal fitting.

5. The optical fiber fixing structure according to claim 3, wherein the optical fiber fixing structure comprises a plurality of optical fiber cables comprising said fiber bundle, said presser plate, said fixing metal fitting and said relay metal fitting, and said fixing metal fittings are stacked on one another and fixed to said second holding section so that end faces of said respective optical fibers of said each optical fiber cable are aligned with each other.

6. The optical fiber fixing structure according to claim 2, wherein said second holding section is fixed to said apparatus body at least at two locations.

7. A projector that projects an image onto a projection plane in accordance with an image signal supplied from outside, the projector comprising:
the optical fiber fixing structure according to claim 1; and
an apparatus body that comprises an optical component to which a plurality of optical fibers are fixed through the optical fiber fixing structure.

8. A projector system that projects an image onto a projection plane according to an image signal supplied from outside, the projector system comprising:
a projector body comprising the optical fiber fixing structure according to claim 1 and an optical component to which a plurality of optical fibers are fixed through the optical fiber fixing structure;
a laser light source that generates a laser beam, serving as a light source of said projector body; and
an optical fiber cable that comprises an optical fiber that supplies the laser beam generated by said laser light source to said projector body.
